(19) United States
(12) Patent Application Publication
(10) Pub. No.: US 2026/0119793 A1
(43) Pub. Date: Apr. 30, 2026

(54) METHOD AND DEVICE FOR PROCESSING NATURAL LANGUAGE

(71) Applicant: Beijing Volcano Engine Technology Co., Ltd., Beijing (CN)

(72) Inventors: Weiqiang YU, Beijing (CN); Jiahui QI, Beijing (CN); Yuncheng LU, Beijing (CN); Dongyu WANG, Beijing (CN); Zheng WANG, Beijing (CN); Yakun LI, Beijing (CN)

(21) Appl. No.: 19/325,134

(22) Filed: Sep. 10, 2025

(30) Foreign Application Priority Data
Oct. 29, 2024 (CN) 202411525569.X

(51) Int. Cl. G06F 40/279; G06F 16/334

(52) U.S. Cl. CPC G06F 40/279; G06F 16/3344

(57) ABSTRACT

Embodiments of the present disclosure provide a method and a device for processing natural language. The method comprises obtaining a set of terms corresponding to an initial input sentence to be processed, wherein the set of terms comprises initial terms included in the initial input sentence and extended terms of the initial terms; performing word order restoring on terms in the set of terms to obtain an extended sentence of the initial input sentence; and obtaining a processing result based on the extended sentence and a Natural Language Process (NLP) model.

### CROSS-REFERENCE TO RELATED APPLICATION(S)

The present disclosure claims the priority from the CN patent application No. 202411525569.X entitled “Method and device for processing natural language” filed with the China National Intellectual Property Administration (CNIPA) on Oct. 29, 2024, the contents of which are hereby incorporated by reference in their entirety.

### FIELD

Embodiments of the present disclosure relate to the field of computer and network communication, and specifically, to a method and a device for processing natural language.

### BACKGROUND

In search engines, such as Opensearch and Elasticsearch, there are usually rich analyzer ecosystems that interfere with query, such as participle, synonym, International Components for Unicode) (ICU), pinyin, etc. The analyzer ecosystem is constructed based on terms, more suitable for scenarios of full-text retrieval.

### SUMMARY

Embodiments of the present disclosure provide a method and a device for processing natural language.

In a first aspect of the present disclosure, embodiments of the present disclosure provide a method for processing natural language. The method comprises:
obtaining a set of terms corresponding to an initial input sentence to be processed, wherein the set of terms comprises initial terms included in the initial input sentence and extended terms of the initial terms;
performing word order restoring on terms in the set of terms to obtain an extended sentence of the initial input sentence;
obtaining a processing result based on the extended sentence and a Natural Language Process (NLP) model.

In a second aspect, embodiments of the present disclosure provide a device for processing natural language, comprising:
an analysis unit, configured to obtain a set of terms corresponding to an initial input sentence to be processed, wherein the set of terms comprises initial terms included in the initial input sentence and extended terms of the initial terms;
a word order restoring unit, configured to obtain an extended sentence of the initial input sentence;
a model processing unit, configured to obtain a processing result based on the extended sentence and a NLP model.

In a third aspect, embodiments of the present disclosure provide an electronic device comprising a processor and a memory;
the memory stores computer-executed instructions;
the processor executes the computer-executed instructions stored in the memory, so that the at least one processor executes the method for processing natural language described in the first aspect and various possible designs of the first aspect.

In a fourth aspect, embodiments of the present disclosure provide a computer-readable storage medium, in which computer-executable instructions are stored, and when the computer-executable instructions are executed by a processor, the method for processing natural language described in the first aspect and various possible designs of the first aspect is realized.

In a fifth aspect, embodiments of the present disclosure provide a computer program product, comprising a computer program, which, when executed by a processor, realizes the method for processing natural language as described in the first aspect and various possible designs of the first aspect.

### BRIEF DESCRIPTION OF THE DRAWINGS

In order to explain the embodiments of the present disclosure or the technical scheme in the prior art more clearly, the drawings needed in the description of the embodiments or the prior art will be briefly introduced below. Obviously, the drawings in the following depiction are some embodiments of the present disclosure, and other drawings can be obtained according to these drawings without inventive effort.

FIG. 1 illustrates a scene diagram of a method for processing natural language according to an embodiment of the present disclosure;

FIG. 2 illustrates a flowchart of a method for processing natural language according to an embodiment of the present disclosure;

FIG. 3 illustrates a flowchart of a method for processing natural language according to another embodiment of the present disclosure;

FIG. 4 illustrates a structural block diagram of a device for processing natural language according to an embodiment of the present disclosure;

FIG. 5 illustrates a structural block diagram of a hardware of a device for processing natural language according to an embodiment of the present disclosure.

### DETAILED DESCRIPTION OF EMBODIMENTS

In order to make the purpose, subject matter and advantages of the embodiment of the disclosure more clear, the subject matter in the embodiment of the disclosure will be described clearly and completely with the attached drawings. Obviously, the described embodiment is a part of the embodiment of the disclosure, but not the whole embodiments. Based on the embodiments in this disclosure, all other embodiments obtained by those skilled in the art without inventive effort belong to the protection scope of this disclosure.

In search engines, such as Opensearch and Elasticsearch, there are usually rich analyzer ecosystems that interfere with query, such as participle, synonyms, ICU, pinyin, etc. The analyzer ecosystem is constructed based on terms, more suitable for scenarios of full-text retrieval.

In recent years, NLP model-related applications show explosive growth. However, there is a lack of bypass intervention means like search engine analyzer in NLP model-related applications, and the search engine analyzer, the term-based analyzer, is not suitable for NLP model. The reason is that the NLP model is very sensitive to separators and natural language word order, and the analyzer-based gets terms, and if terms are directly used as the input of the NLP model, the processing effect would be poor.

For example, when searching “occupational injury disputes caused by traffic accidents”, we can get the following similar results after the intervention of the search engine analyzer:
“Traffic, accident, cause, occupational injury, occupational injury, should, exclude, dispute, because, other, occupation, injury, reason, scene, cause, injury”.

This query splitting into terms is suitable for full-text retrieval, but not for the input of a natural language model, especially for semantic retrieval or as a natural language processing prompt.

Embodiments of the present disclosure provide a method and a device for processing natural language, to overcome the above problem.

In order to solve the above technical problems, the embodiment of the present disclosure provides a method for processing natural language. A search engine analyzer is reused to obtain the initial terms and extended terms included in the initial input sentence to obtain a set of terms, and then restore the word order of the set of terms to obtain the extended sentence with a smooth word order so as to expand and enhance the initial input sentence. As such, the obtained extended sentence can be better understood by the NLP model, and then combined with the NLP model for natural language processing to improve the accuracy and stability of the processing result.

Embodiments of the present disclosure provide a method and a device for processing natural language. The method comprises obtaining a set of terms corresponding to an initial input sentence to be processed, wherein the set of terms comprises initial terms included in the initial input sentence and extended terms of the initial terms; performing word order restoring on terms in the set of terms to obtain an extended sentence of the initial input sentence; obtaining a processing result based on the extended sentence and a Natural Language Process (NLP) model. In the embodiment of the present disclosure, the initial input sentence can be extended and enhanced by obtaining the initial terms and the extended terms included in the initial input sentence and restoring the initial input sentence to the extended sentence with a smooth word order. As such, the obtained extended sentence can be better understood by the NLP model, and then combined with the NLP model for natural language processing to improve the accuracy and stability of the processing result.

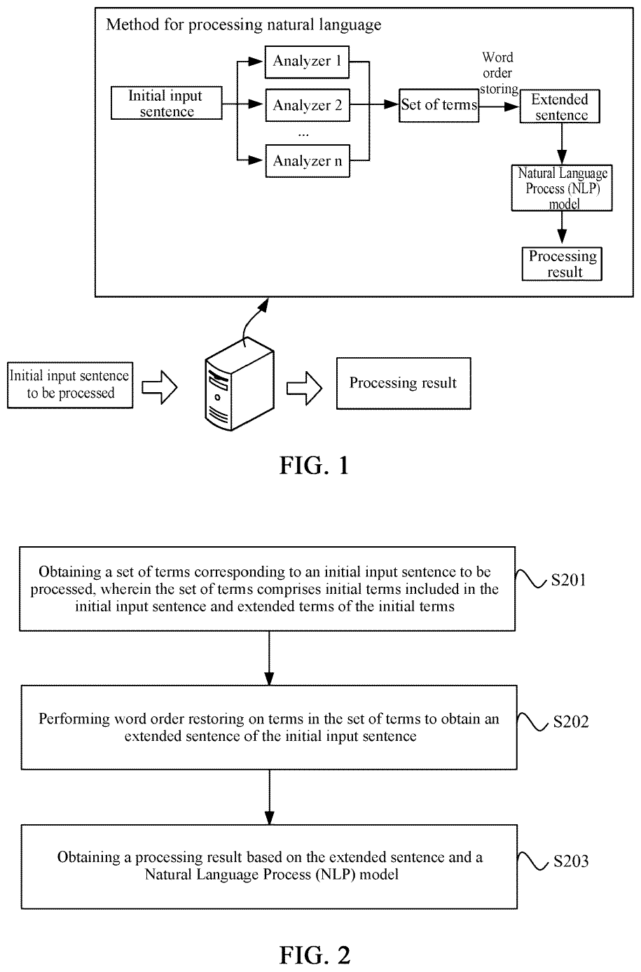

As shown in FIG. 1, the application scenario of the method for processing natural language in the embodiment of the present disclosure can be applied to any electronic device such as a terminal device or a server. The specific scenario can be any scenario in which the NLP model is applied, for example, any natural language processing scenario such as various chatbots, data retrieval, such as retrieval of professional literature knowledge base and document knowledge base, shopping guide, after-sales robots and the like. Firstly, the initial input sentence to be processed can be obtained, and the search engine analyzer is reused to obtain the set of terms corresponding to the initial input sentence, wherein the set of terms comprises initial terms included in the initial input sentence and extended terms of the initial term; then word order restoring is performed on the terms in the set of terms to obtain an extended sentence of the initial input sentence; the processing result is obtained based on the extended sentence and the NLP model.

The method for processing natural language of the present disclosure will be described in detail with specific examples.

Referring to FIG. 2, FIG. 2 illustrates a flowchart of a method for processing natural language according to an embodiment of the present disclosure. The method of this embodiment can be applied to any electronic device such as a terminal device or a server, and the method for processing natural language includes:
S201, obtaining a set of terms corresponding to an initial input sentence to be processed, wherein the set of terms comprises initial terms included in the initial input sentence and extended terms of the initial terms.

In this embodiment, in a scene based on natural language (sentence) processing such as semantic retrieval, first, the initial input sentence (query) to be processed is obtained, and the initial input sentence is a sentence of natural language, and then, based on the initial input sentence to be processed, an initial terms included in the initial input sentence and extended terms of the initial terms can be obtained to form a set of terms.

Optionally, in this embodiment, the search engine analyzer can be called to obtain the set of terms corresponding to the initial input sentence, wherein the search engine can be a search engine comprising but not limited to Opensearch, Elasticsearch, etc., and the analyzer is a component used for processing text data in the search engine, which can be used for realizing specific text processing requirements, comprising but not limited to one or more of the following: tokenizer, synonym analyzer, ICU, pinyin analyzer, etc. The input of the analyzer can be any form of text (sentence or term) and the output can be term. Of course, this embodiment is not limited to using the search engine analyzer to obtain the set of terms corresponding to the initial input sentence, but also can use any other feasible way to obtain the set of terms corresponding to the initial input sentence, such as using other tokenizers, synonym tools, pinyin tools, ICU tools, etc.

Considering that in the retrieval scene based on terms, such as full-text retrieval scene, rich analyzer ecosystem is usually used to intervene the initial query, such as participle, synonyms, ICU, pinyin and other term-based analyzers. The final terms can be enriched and the retrieval accuracy can be improved. In this embodiment, in order to enrich and expand the initial input sentence in the scenes based on natural language (sentence) processing such as semantic retrieval, the analyzer ecosystem of the search engine is considered to be reused to intervene the initial input sentence, that is, one or more term-based analyzers comprising but not limited to participle, synonym, ICU, pinyin, etc. can also be used to process the initial input sentence.

The set of terms corresponding to the initial input sentence can specifically include the initial terms included in the initial input sentence (which can be obtained directly through a tokenizer) and the extended terms of the initial terms (which can be obtained through other term-based analyzers). For example, the extended terms of the initial terms include but are not limited to one or more of the following: synonyms of the initial terms (obtained through a synonym analyzer), pinyin of the initial terms (obtained through a pinyin analyzer), and terms with standard formats corresponding to the initial terms (obtained through an ICU analyzer).

For example, supposing that the initial input sentence is “occupational injury disputes caused by traffic accidents”, we can get the following set of terms after the intervention of the analyzers:
“Traffic, accident, cause, occupational injury, occupational injury, should, exclude, dispute, because, other, occupation, injury, reason, scene, cause, injury”.

In addition, when obtaining each term in the set of terms, especially when each term is obtained through the search engine analyzer, the piece of position information of each term can also be obtained, comprising the corresponding position and offset of the terms in the initial input sentence, wherein the position is used to indicate the corresponding order of the terms in the initial sentence, and the offset is used to indicate the position of the beginning character and the termination character, so that the terms can be accurately mapped back to the initial input sentence, comprising the startoffset and the endoffset; the position and offset of the extended terms of the initial terms usually have a certain inheritance relationship with the position and offset of the initial terms.

S202, performing word order restoring on terms in the set of terms to obtain an extended sentence of the initial input sentence.

In this embodiment, since there are the extended terms of the initial terms in the set of terms besides the initial terms, and the order of the initial terms and the extended terms may not conform to the word order, it is necessary to reorder the terms in the set of terms to obtain a complete and fluent sentence, that is, the extended sentence of the initial input sentence. The extended sentence is more friendly to the NLP model in the following steps and more suitable for semantic retrieval scenarios, and comprises the initial input sentence, and a sentence constructed based on the extended terms. Any known and feasible method can be adopted for the ranking of terms, and there is no restriction in this embodiment.

For example, in the above example, word order restoring is performed for the terms in the set of terms:
“Traffic, accident, cause, occupational injury, occupational injury, should, exclude, dispute, because, other, occupation, injury, reason, scene, cause, injury”.

It can be obtained that “occupational injury disputes caused by traffic accidents, industrial injuries are caused by work reasons, and other scenarios should be excluded”.

S203, obtaining a processing result based on the extended sentence and a NLP model.

In this embodiment, after the extended sentence is obtained, the NLP model can be used for further intervention, comprising the extended sentence being used as the input of the NLP model directly to perform natural language processing tasks comprising but not limited to retrieval, question-and-answer by the NLP model, or the extended sentence being further processed through the NLP model, and then other natural language processing is performed on the processing result. The NLP model is a sub-field of computer science, information engineering and artificial intelligence, focusing on human-computer language interaction and discussing how to process and apply natural language. In this embodiment, the NLP model can be used to further process the extended sentence, or semantic retrieval can be realized based on the NLP model.

In an alternative embodiment, the extended sentence can be input into the NLP model to obtain rewritten extended sentence, and the natural language processing is performed according to the rewritten extended sentence to obtain the processing result.

In this embodiment, based on the NLP model, the extended sentence can be further rewritten to make the semantics of the extended sentence richer and more comprehensive, or errors in the extended sentence can be corrected, or the extended sentence can be rewritten into a specific format (such as prompt) to be applied to any natural language processing scene, for example, to the search engine for retrieval, and to other scenes, or to other arbitrary natural language processing task to obtain more accurate processing result, and the specific rewriting process and the subsequent application of the rewritten extended sentence are not limited in this embodiment. For example, upon searching a database (such as any database such as knowledge base) based on natural language, the database can be searched based on the rewritten extended sentence; upon question-answer based on natural language (such as chat robot, shopping guide robot, after-sales robot, etc.), you can ask questions based on the rewritten extended sentence to get answers.

In another alternative embodiment, the extended sentence can be input into the NLP model, the sentence vector corresponding to the extended sentence can be obtained through the NLP model, and the natural language processing can be performed according to the sentence vector to obtain the processing result.

In this embodiment, embedding can be performed on the extended sentence via the NLP model to obtain the sentence vector corresponding to the extended sentence, and then vector processing is performed based on the sentence vector, such as vector retrieval and other vector-based operations, to obtain the more accurate result. The specific embedding and vector retrieval process are not limited in this embodiment. For example, when searching a database (such as any database such as knowledge base) based on natural language, the vector search can be performed on the database based on sentence vector of extended sentence.

In another alternative embodiment, the extended sentence can be queried through the natural language model to obtain a query result and a matching score between the query result and the extended sentence.

In this embodiment, the semantic retrieval of the extended sentence can be directly carried out with the help of the NLP model, for example, the semantic retrieval can be carried out from a preset database, and the query result matched with the extended sentence can be output. Meanwhile, the matching score between the query result and the extended sentence can be given, wherein the specific process of searching and giving the matching score based on the NLP model is not limited in this embodiment. For example, when searching a database (e.g., any database such as knowledge base) based on the natural language, we can directly use the NLP model to search in the database to obtain one or more search results, and give the matching score between the search results and extended sentence.

Optionally, the above three processing embodiments based on extended sentences and NLP model s can be used in any combination without conflict.

Embodiments of the present disclosure provide a method and a device for processing natural language. The method comprises obtaining a set of terms corresponding to an initial input sentence to be processed, wherein the set of terms comprises initial terms included in the initial input sentence and extended terms of the initial terms; performing word order restoring on terms in the set of terms to obtain an extended sentence of the initial input sentence; obtaining a processing result based on the extended sentence and a Natural Language Process (NLP) model. In the embodiment of the present disclosure, the initial input sentence can be extended and enhanced by obtaining the initial terms and the extended terms included in the initial input sentence and restoring the initial input sentence to the extended sentence with a smooth word order. As such, the obtained extended sentence can be better understood by the NLP model, and then combined with the NLP model for natural language processing to improve the accuracy and stability of the processing result.

In addition, the main flow of natural language processing does not change, but the intervention is added in the recall and call of the NLP model, that is, the above-mentioned obtaining the set of terms and performing word order restoring to obtain the extended sentence of the initial input sentence. In addition, recall and question-and-answer adjustment and optimization can be carried out quickly anytime and anywhere, and all the badcase in the actual landing process converge quickly, for example:
In the scene of fresh shopping guide, the questions and answers of some regional dialects are poor, which can be solved by directly configuring dialect descriptions;
The “divergent function” is not understood by the “multi-separating” NLP model, and can be solved by directly configuring the divergent function description;
The answer to the “occupational injury” scenario is unstable, then the description+command control sentence of occupational injury is directly configured.

On the basis of any of the above embodiments, performing word order restoring on terms in the set of terms to obtain an extended sentence of the initial input sentence in S202 specifically includes:
traversing terms in the set of terms, obtaining terms with pieces of position information connected from the set of terms to construct an extended sentence, wherein pieces of position information are corresponding positions and/or offsets of terms in the initial input sentence.

In this embodiment, when the initial terms and the extended term of the initial input sentence are obtained by the search engine analyzer, the piece of position information of each term, comprising the corresponding the position and offset in the initial input sentence, can also be obtained, which can be used to reflect the word order of the terms. The position and offset of the extended terms of the initial terms usually have a certain inheritance relationship with the position and offset of the initial terms, so we can restore the word order of the set of terms based on the pieces of position information, and then we can construct the extended sentence by obtaining the terms with pieces of position information connected in turn.

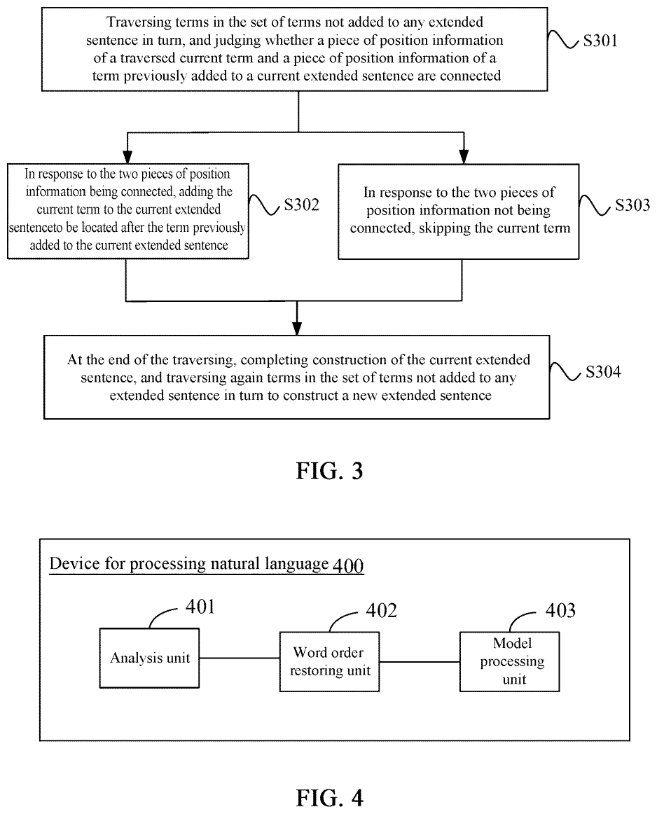

Optionally, when traversing the terms in the set of terms, obtaining the terms with pieces of position information connected from the set of terms to construct the extended sentence, as shown in FIG. 3, comprises:
S301, traversing terms in the set of terms not added to any extended sentence in turn, and judging whether a piece of position information of a traversed current term and a piece of position information of a term previously added to a current extended sentence are connected;

In response to the two pieces of position information being connected, executing S302; in response to the two pieces of position information not being connected, executing S303.
S302, in response to the two pieces of position information being connected, adding the current term to the current extended sentence and located after the term previously added to the current extended sentence;
S303, in response to the two pieces of position information not being connected, skipping the current term.

Further, after S302 or S303, it is judged whether the current traversal is finished, and if not, the next term in the set of terms not added to any extended sentence is traversed, and S301 is executed again; If not finished, S304 is executed;
S304, at the end of the traversing, completing construction of the current extended sentence, and traversing again terms in the set of terms not added to any extended sentence in turn to construct a new extended sentence.

In this embodiment, since the position and offset of the extended terms of the initial terms usually have a certain inheritance relationship with the position and offset of the initial terms, there will be cases where the position and offset overlap. Specifically, the startoffset of the extended terms of the initial terms are the same as that of the initial terms, but the positions will always be added. In particular, the more the analyzer is used, the more serious the overlap between position and offset is.

For example, in the above example, the initial input sentence is “occupational injury disputes caused by traffic accidents”, and the initial terms obtained through the tokenizer comprise “traffic, accident, cause, occupational injury, disputes”, and the extended term (or short sentences) of the initial terms “occupational injury” can be obtained through some analyzers, such as “occupational injury is caused by work reasons” and “other scenes should be excluded”. The startoffset of the initial term “dispute” is connected with the endoffset of the initial term “occupational injury”, and the startoffset of the two extended terms (or short sentences) of the initial terms “occupational injury” are the same as that of the initial terms “occupational injury”, but the end offsets of the two extended terms (or short sentences) of the initial terms “occupational injury” are different from that of the initial terms “occupational injury”, and thus is not connected with the startoffset of the initial terms “dispute”. Therefore, for the initial terms “occupational injury”, the following term can be determined as “dispute” by the rule that the endoffset of the previous term is connected with the endoffset of the latter term. Therefore, whether the terms are connected can be judged by whether the offset between the terms is connected.

For another example, if the analyzer further separates the extended terms of the initial terms, for example, separating the extended terms (or a short sentence), “occupational injury is caused by work reasons” and “other scenes should be excluded” of the initial term “occupational injury”, to obtain the extended terms “occupational injury, should, be, excluded, because, other, occupation, injury, reason, cause, injury”, and the startoffset of these extended terms are the same as that of the initial term “occupational injury”. However, the positions of each extended term (or short sentence) of the same extended term (or short sentence) divided are ascending, so for terms with the same startoffset, the separated extended term (or short sentence) can be constructed into a complete extended term (or short sentence) according to whether the position is connected or not. That is to say, “Work-related injuries should exclude injuries caused by other work-related injuries” is reconstructed into “Work-related injuries caused by work-related injuries” and “Other scenes should be excluded” according to the position. Therefore, it can be judged whether the terms are connected by whether the position between the terms are connected under the same startoffset.

Based on this, in this embodiment, the terms in the set of terms can be traversed in turn, and each term can be used only once, so the unused terms in the set of terms (that is, the terms not added to any extended sentence) can be traversed in turn. During the traversal process, for the currently traversed term, it can be judged whether a piece of position information of the current term and a piece of position information of the term previously added to the current extended sentence are connected. In response to the two pieces of position information being connected, it means that the current term is connected with the term previously added to the current extended sentence, and the current term is added to the current extended sentence and added after the term previously added to the current extended sentence, and then the next term is traversed. In response to the two pieces of position information not being connected, it means that the current term is not connected with term previously added to the current extended sentence, then the current term is skipped and the next term is traversed. At the end of the traversing, the construction of the current extended sentence is completed. However, because some terms are skipped in this traversal process, that is, these terms are not used (that is, terms not added to any extended sentence), we can traverse the unused terms in the set of terms (that is, terms not added to any extended sentence) in turn to construct a new extended sentence. In the above process, each traversal can construct an extended sentence.

When judging whether the piece of position information of the traversed current term and the piece of position information of the term previously added to the current extended sentence are connected, it can specifically include:
judging whether a startoffset of the current term and an endoffset of term previously added to the current extended sentence are connected, and/or, judging whether the startoffset of current term and that of the term previously added to the current extended sentence are the same, and a position of the term previously added to the current extended sentence is in an increasing relationship with that of the current term;
in response to the startoffset of the current term and the endoffset of the term previously added to the current extended sentence being connected, or the startoffset of the current term and that of the term previously added to the current extended sentence being the same, and the position of the term previously added to the current extended sentence being in the increasing relationship with that of the current term, determining that the piece of position information of the current term and the piece of position information of the term previously added to the current extended sentence are connected.

That is, when the initial startoffset of the current term is connected with the endoffset of the term previously added to the current extended sentence, or, the startoffset of the current term is the same as that of term previously added to the current extended sentence, and the position of term previously added to the current extended sentence is in an increasing relationship with the position of the current term, it can be determined that the piece of position information of the current term and that of the term previously added to the current extended sentence are connected if one of the two conditions is met; it can be determined that the piece of position information of the current term and that of the term previously added to the current extended sentence are not connected if the two conditions are not met.

On the basis of any of the above-mentioned embodiments, since each traversal process is to traverse the unused terms in the set of terms (that is, the terms not added to any extended sentence) in turn, in order to judge whether each term is used during traversal, that is, judging whether the terms are not added to any extended sentence, an array can be created according to the set of terms, in which each bit of the array is used to store the corresponding state of each term in the set of terms. The corresponding state of the term is used to characterize whether the term has been added to any extended sentence. Optionally, the array can be a bool array, with 1 indicating being added to any extended sentence and 0 indicating being not added to any extended sentence. In the process of traversal, the terms in the set of terms not added to any extended sentence can be traversed in turn according to the array, that is, the terms with the state value of 0 in the array can be obtained from the set of terms in turn for traversal. In response to a term being added to an extended sentence, a corresponding state of the term is updated in the array, that is, 0 is updated to 1, which can quickly judge whether each term is used and improve the traversal efficiency.

Corresponding to the method for processing natural language of the above embodiment, FIG. 4 illustrates a structural block diagram of a device for processing natural language according to an embodiment of the present disclosure. For convenience of explanation, only parts related to the embodiment of the present disclosure are shown. Referring to FIG. 4, the device 400 for processing natural language includes an analysis unit 401, a word order restoring unit 402, and a model processing unit 403.

The analysis unit 401 is configured to obtain a set of terms corresponding to an initial input sentence to be processed, wherein the set of terms comprises initial terms included in the initial input sentence and extended terms of the initial terms;

The word order restoring unit 402, configured to perform word order restoring on terms in the set of terms to obtain an extended sentence of the initial input sentence;

The model processing unit 403 is configured to obtain a processing result based on the extended sentence and the NLP model.

In one or more embodiments of the present disclosure, the word order restoring unit 402, when performing word order restoring on the terms in the set of terms to obtain the extended sentence of the initial input sentence, is configured to:
traverse the terms in the set of terms, obtain the terms with pieces of position information connected from the set of terms to construct the extended sentence, wherein pieces of position information are corresponding positions and/or offsets of the terms in the initial input sentence.

In one or more embodiments of the present disclosure, the word order restoring unit 402, when traversing terms in the set of terms to obtain the terms with the pieces of position information connected from the set of terms to construct the extended sentence, is configured to:
traverse terms in the set of terms not added to any extended sentence in turn, and judge whether a piece of position information of the traversed current term and a piece of position information of the term previously added to the current extended sentence are connected;
in response to the two pieces of position information being connected, add current term to the current extended sentence to be located after term previously added to the current extended sentence; or
in response to the two pieces of position information not being connected, skip the current term;
at the end of the traversing, complete construction of the current extended sentence, and traverse again terms in the set of terms not added to any extended sentence in turn to construct a new extended sentence.

In one or more embodiments of the present disclosure, the word order restoring unit 402 is further configured to:
create an array according to the set of terms, wherein each bit of the array is used for storing a state corresponding to each term in the set of terms, and a state corresponding to a term is used for charactering whether the term has been added to any extended sentence;
in a process of the traversing, in response to a term being added to an extended sentence, update a state corresponding to the term in the array;
correspondingly, the word order restoring unit 402, when traversing terms in the set of terms not added to any extended sentence in turn, is configured to:
traverse terms in the set of terms not added to any extended sentence in turn according to the array.

In one or more embodiments of the present disclosure, the word order restoring unit 402, when judging whether the piece of position information of the traversed current term and the piece of position information of the term previously added to the current extended sentence are connected, is configured to:
judge whether a position and/or offset of the traversed current term and a position and/or offset of the term added to the current extended sentence are connected;

In one or more embodiments of the present disclosure, the word order restoring unit 402, when judging whether the position and/or offset of the traversed current term and the position and/or offset of the term added to the current extended sentence are connected, is configured to:
judge whether a startoffset of the current term and an endoffset of the term previously added to the current extended sentence are connected, and/or, judge whether the startoffset of the current term and that of the term previously added to the current extended sentence are the same, and the position of the term previously added to the current extended sentence is in an increasing relationship with that of the current term;
in response to the startoffset of the current term and the endoffset of the term previously added to the current extended sentence being connected, or the startoffset of the current term and that of the term previously added to the current extended sentence being the same, and the position of the term previously added to the current extended sentence is in the increasing relationship with that of the current term, determine that the piece of position information and the current term and the piece of position information of the term previously added to the current extended sentence are connected.

In one or more embodiments of the present disclosure, the model processing unit 403, when obtaining a processing result based on the extended sentence and a NLP model, is configured to:
input the extended sentence into the NLP model, rewrite the extended sentence through the NLP model to obtain a rewritten extended sentence, and perform natural language processing according to the rewritten extended sentence to obtain the processing result.

In one or more embodiments of the present disclosure, the model processing unit 403, when obtaining a processing result based on the extended sentence and a NLP model, is configured to:
input the extended sentence into the NLP model, obtain sentence vector corresponding to the extended sentence through the NLP model, and perform vector processing according to the sentence vector to obtain the processing result.

In one or more embodiments of the present disclosure, the model processing unit 403, when obtaining a processing result based on the extended sentence and a NLP model, is configured to:
query the extended sentence through the natural language model to obtain a query result and a matching score between the query result and the extended sentence.

In one or more embodiments of the present disclosure, the extended terms of the initial terms include one or more of the following:
synonyms of the initial terms, pinyin of the initial terms, and terms in standard format corresponding to the initial terms.

In one or more embodiments of the present disclosure, the analyzing unit 401, when obtaining a set of terms corresponding to an initial input sentence to be processed, is configured to:
call an analyzer of a search engine to obtain the set of terms corresponding to the initial input sentence to be processed, wherein the analyzer is a component of the search engine for processing text data, and the analyzer comprises one or more of the following analyzers: a tokenizer, a synonym analyzer, a pinyin analyzer, and a multilingual text analyzer.

The device provided in this embodiment can be used to implement the technical scheme of the above method embodiment, and the implementation principle and technical effect are similar, so the details of this embodiment are not repeated here.

In order to realize the above embodiment, the embodiment of the present disclosure also provides an electronic device.

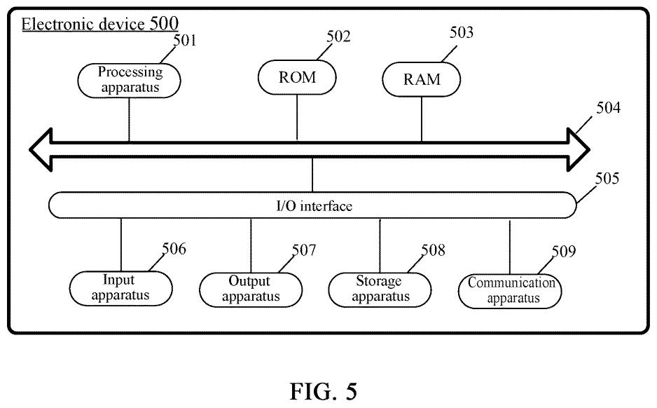

Referring to FIG. 5, it shows a structural schematic diagram of an electronic apparatus 500 suitable for implementing the embodiment of the present disclosure. The electronic apparatus 500 may be a terminal device or a server. The terminal device may include, but is not limited to, mobile terminals such as mobile phones, notebook computers, digital broadcast receivers, Personal Digital Assistant (PDA), Tablet Computer, Portable Media Player (PMP), vehicle-mounted terminals (such as vehicle-mounted navigation terminals), and fixed terminals such as digital TVs and desktop computers. The electronic device shown in FIG. 5 is only an example, and should not bring any limitation to the function and application scope of the embodiment of the present disclosure.

As shown in FIG. 5, the electronic apparatus 500 may include a processing apparatus (such as a central processing unit, a graphics processor, etc.) 501, which may perform various appropriate actions and processes according to a program stored in a Read Only Memory (ROM) 502 or a program loaded from a storage apparatus 508 into a Random Access Memory (RAM) 503. In the RAM 503, various programs and data required for the operation of the electronic apparatus 500 are also stored. A processing apparatus 501, a ROM 502 and a RAM 503 are connected to each other through a bus 504. An input/output (I/O) interface 505 is also connected to the bus 504.

Generally, the following apparatus can be connected to the I/O interface 505: an input apparatus 506 comprising, for example, a touch screen, a touch pad, a keyboard, a mouse, a camera, a microphone, an accelerometer, a gyroscope, etc.; an output apparatus 507 comprising, for example, a Liquid Crystal Display (LCD), a speaker, a vibrator, etc.; a storage apparatus comprising, for example, a magnetic tape, a hard disk, etc.; a communication apparatus 509. The communication apparatus 509 may allow the electronic apparatus 500 to communicate wirelessly or wired with other devices to exchange data. Although FIG. 5 shows the electronic apparatus 500 with various apparatus, it should be understood that it is not required to implement or have all the apparatus shown. More or fewer apparatus may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from the network through the communication apparatus 509, or installed from the storage apparatus 508 or from the ROM 502. When the computer program is executed by the processing apparatus 501, the above functions defined in the method of the embodiment of the present disclosure are performed.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, a computer-readable storage medium can be any tangible medium containing or storing a program, which can be used by or in combination with an instruction execution system, apparatus or device. In this disclosure, a computer-readable signal medium may include a data signal propagated in baseband or as part of a carrier wave, in which computer-readable program codes are carried. This propagated data signal can take many forms, comprising but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, comprising but not limited to: wires, optical cables, RF (radio frequency) and the like, or any suitable combination of the above.

The computer-readable medium may be included in the electronic device; or it can exist alone without being assembled into the electronic device.

The computer-readable medium carries one or more programs, which, when executed by the electronic device, cause the electronic device to perform the method shown in the above embodiments.

Computer program codes for performing the operations of the present disclosure may be written in one or more programming languages or combinations thereof, comprising object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case of involving a remote computer, the remote computer can be connected to a user computer through any kind of network, comprising a Local Area Network (LAN) or a Wide Area Network (WAN), or can be connected to an external computer (for example, by using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases. For example, the first acquisition unit can also be described as “the unit that obtains at least two Internet protocol addresses”.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In a first aspect, according to one or more embodiments of the present disclosure, there is provided a method for processing natural language, comprising:
obtaining a set of terms corresponding to an initial input sentence to be processed, wherein the set of terms comprises initial terms included in the initial input sentence and extended terms of the initial terms;
performing word order restoring on terms in the set of terms to obtain an extended sentence of the initial input sentence;
obtaining a processing result based on the extended sentence and a Natural Language Process (NLP) model.

According to one or more embodiments of the present disclosure, performing word order restoring on the terms in the set of terms to obtain the extended sentence of the initial input sentence comprises:
traversing terms in the set of terms, obtaining terms with pieces of position information connected from the set of terms to construct an extended sentence, wherein pieces of position information are corresponding positions and/or offsets of terms in the initial input sentence.

According to one or more embodiments of the present disclosure, traversing the terms in the set of terms, obtaining the terms with the pieces of position information connected from the set of terms to construct the extended sentence comprises:
traversing terms in the set of terms not added to any extended sentence in turn, and judging whether a piece of position information of a traversed current term and a piece of position information of a term previously added to the current extended sentence are connected;
in response to the two pieces of position information being connected, adding the current term to the current extended sentence to be located after the term previously added to the current extended sentence; or
in response to with two pieces of position information not being connected, skipping the current term;
at the end of the traversing, completing construction of the current extended sentence, and traversing again terms in the set of terms not added to any extended sentence in turn to construct a new extended sentence.

According to one or more embodiments of the present disclosure, the method further comprises:
creating an array according to the set of terms, wherein each bit of the array is used for storing a state corresponding to each term in the set of terms, and a state corresponding to a term is used for charactering whether the term has been added to any extended sentence;
in a process of the traversing, in response to a term being added to an extended sentence, updating a state corresponding to the term in the array;
correspondingly, traversing terms in the set of terms not added to any extended sentence in turn, comprising:
traversing the terms in the set of terms not added to any extended sentence in turn according to the array.

According to one or more embodiments of the present disclosure, judging whether the piece of position information of the traversed current term and the piece of position information of the term previously added to the current extended sentence are connected comprises:
judging whether a position and/or offset of the traversed current term and a position and/or offset of the term previously added to the current extended sentence are connected;
According to one or more embodiments of the present disclosure, judging whether the position and/or offset of the traversed current term and the position and/or offset of the term previously added to the current extended sentence are connected comprises:
judging whether a startoffset of the current term and an endoffset of the term previously added to the current extended sentence are connected, and/or, judging whether the startoffset of the current term and that of the term previously added to the current extended sentence are the same, and a position of the term previously added to the current extended sentence is in an increasing relationship with that of the current term;
in response to the startoffset of the current term and the endoffset of the term previously added to the current extended sentence being connected, or the startoffset of the current term and that of the term previously added to the current extended sentence being the same, and the position of the term previously added to the current extended sentence is in the increasing relationship with that of the current term, determining that the piece of position information of the current term and the piece of position information of the term previously added to the current extended sentence are connected.

According to one or more embodiments of the present disclosure, obtaining the processing result based on the extended sentence and the NLP model comprises:
inputting the extended sentence into the NLP model, rewriting the extended sentence through the NLP model to obtain a rewritten extended sentence, and performing natural language processing according to the rewritten extended sentence to obtain the processing result.

According to one or more embodiments of the present disclosure, obtaining the processing result based on the extended sentence and the NLP model comprises:
inputting the extended sentence into the NLP model, obtaining a sentence vector corresponding to the extended sentence through the NLP model, and performing vector processing according to the sentence vector to obtain the processing result.

According to one or more embodiments of the present disclosure, obtaining the processing result based on the extended sentence and the NLP model comprises:
querying the extended sentence through the natural language model to obtain a query result and a matching score between the query result and the extended sentence.

According to one or more embodiments of the present disclosure, the extended terms of the initial terms include one or more of the following:
synonyms of the initial terms, pinyin of the initial terms, and terms in standard format corresponding to the initial terms.

According to one or more embodiments of the present disclosure, obtaining the set of terms corresponding to the initial input sentence to be processed comprises:
calling an analyzer of a search engine to obtain the set of terms corresponding to the initial input sentence to be processed, wherein the analyzer is a component of the search engine for processing text data, and the analyzer comprises one or more of the following analyzers: a tokenizer, a synonym analyzer, a pinyin analyzer, and a multilingual text analyzer.

In a second aspect, according to one or more embodiments of the present disclosure, there is provided a device for processing natural language, comprising:
an analysis unit for obtaining a set of terms corresponding to an initial input sentence to be processed, wherein the set of terms comprises initial terms included in the initial input sentence and extended terms of the initial terms;
a word order restoring unit for performing word order restoring on terms in the set of terms to obtain an extended sentence of the initial input sentence;
a model processing unit for obtaining a processing result based on the extended sentence and a NLP model.

According to one or more embodiments of the present disclosure, when performing word order restoring terms in the set of terms to obtain an extended sentence of the initial input sentence, the word order restoring unit is configured to:
traverse terms in the set of terms, obtain terms with pieces of position information connected from the set of terms to construct an extended sentence, wherein pieces of position information are corresponding positions and/or offsets of terms in the initial input sentence.

According to one or more embodiments of the present disclosure, when traversing terms in the set of terms, obtaining terms with pieces of position information connected from the set of terms to construct an extended sentence, the word order restoring unit is configured to:
traverse terms in the set of terms not added to any extended sentence in turn, and judge whether a piece of position information of a traversed current term and a piece of position information of a term previously added to a current extended sentence are connected;
in response to the two pieces of position information being connected, add the current term to the current extended sentence to be located after the term previously added to the current extended sentence; or
in response to the two pieces of position information not being connected, skip the current term;
at the end of the traversing, complete construction of the current extended sentence, and traversing again terms in the set of terms not added to any extended sentence in turn to construct a new extended sentence.

According to one or more embodiments of the present disclosure, the word order restoring unit is further configured to:
create an array according to the set of terms, wherein each bit of the array is used for storing a state corresponding to each term in the set of terms, and a state corresponding to a term is used for charactering whether the term has been added to any extended sentence;
in a process of the traversing, in response to a term being added to an extended sentence, update a state corresponding to the term in the array;
correspondingly, traverse terms in the set of terms not added to any extended sentence in turn, comprising:
traverse the terms in the set of terms not added to any extended sentence in turn according to the array.

According to one or more embodiments of the present disclosure, when judging whether the piece of position information of the traversed current term and the piece of position information of the term previously added to the current extended sentence are connected, the word order restoring unit, is configured to:
judge whether the position and/or offset of the traversed current term and the position and/or offset of the term previously added to the current extended sentence are connected.

According to one or more embodiments of the present disclosure, when judging whether the position and/or offset of the traversed current term and the position and/or offset of the term previously added to the current extended sentence are connected, the word order restoring unit is configured to:
judge whether a startoffset of the current term and an endoffset of the term previously added to the current extended sentence are connected, and/or, judge whether the startoffset of the current term and that of the term previously added to the current extended sentence are the same, and a position of the term previously added to the current extended sentence is in an increasing relationship with that of the current term;
in response to the startoffset of the current term and the endoffset of the term previously added to the current extended sentence being connected, or the startoffset of the current term and that of the term previously added to the current extended sentence being the same, and the position of term previously added to the current extended sentence being in the increasing relationship with that of the current term, determining that the piece of position information of the current term and the piece of position information of the term previously added to the current extended sentence are connected.

According to one or more embodiments of the present disclosure, when obtaining a processing result based on the extended sentence and a NLP model, the model processing unit, is configured to:
input the extended sentence into the NLP model, rewrite the extended sentence through the NLP model to obtain a rewritten extended sentence, and perform natural language processing according to the rewritten extended sentence to obtain the processing result.

According to one or more embodiments of the present disclosure, when obtaining a processing result based on the extended sentence and a NLP model, the model processing unit is configured to:
input the extended sentence into the NLP model, obtain a sentence vector corresponding to the extended sentence through the NLP model, and perform vector processing according to the sentence vector to obtain the processing result.

According to one or more embodiments of the present disclosure, when obtaining a processing result based on the extended sentence and a NLP model model, the model processing unit is configured to:
query the extended sentence through the natural language model to obtain a query result and a matching score between the query result and the extended sentence.

According to one or more embodiments of the present disclosure, the extended terms of the initial terms include one or more of the following:
synonyms of the initial terms, pinyin of the initial terms, and terms in standard format corresponding to the initial terms.

According to one or more embodiments of the present disclosure, when obtaining a set of terms corresponding to an initial input sentence to be processed, the analyzing unit is configured to:
call an analyzer of a search engine to obtain the set of terms corresponding to the initial input sentence to be processed, wherein the analyzer is a component of the search engine for processing text data, and the analyzer comprises one or more of the following analyzers: a tokenizer, a synonym analyzer, a pinyin analyzer, and a multilingual text analyzer.

In a third aspect, according to one or more embodiments of the present disclosure, there is provided an electronic device comprising at least one processor and a memory;
the memory stores computer-executed instructions;
the at least one processor executing computer-executed instructions stored in the memory, so that the processor performs the method for processing natural language described in the first aspect and various possible designs of the first aspect.

In a fourth aspect, according to one or more embodiments of the present disclosure, there is provided with a computer-readable storage medium, in which computer-executable instructions are stored, and when the computer-executable instructions are executed by a processor, the method for processing natural language described in the first aspect and various possible designs of the first aspect above is realized.

In a fifth aspect, according to one or more embodiments of the present disclosure, there is provided a computer program product, comprising a computer program, which, when executed by a processor, realizes the method for processing natural language as described in the first aspect and various possible designs of the first aspect above.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter is described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

I/We claim:

1. A method for processing natural language, comprising:
obtaining a set of terms corresponding to an initial input sentence, wherein the set of terms comprises initial terms included in the initial input sentence and extended terms of the initial terms;
performing word order restoring on terms in the set of terms to obtain an extended sentence of the initial input sentence; and
obtaining a processing result based on the extended sentence and a Natural Language Process (NLP) model.

2. The method according to claim 1, wherein performing word order restoring on the terms in the set of terms to obtain the extended sentence of the initial input sentence comprises:
traversing terms in the set of terms, and obtaining terms with pieces of position information connected from the set of terms to construct an extended sentence, wherein the pieces of position information are corresponding positions and/or offsets of terms in the initial input sentence.

3. The method according to claim 2, where traversing the terms in the set of terms, and obtaining the terms with the pieces of position information connected from the set of terms to construct the extended sentence comprises:
traversing terms in the set of terms not added to any extended sentence in turn, and judging whether a piece of position information of a traversed current term and a piece of position information of a term previously added to a current extended sentence are connected;
in response to the two pieces of position information being connected, adding the current term to the current extended sentence to be located after the term previously added to the current extended sentence; or
in response to the two pieces of position information not being connected, skipping the current term; and
at the end of the traversing, completing construction of the current extended sentence, and traversing again terms in the set of terms not added to any extended sentence in turn to construct a new extended sentence.

4. The method according to claim 3, wherein the method further comprises:
creating an array according to the set of terms, wherein each bit of the array is used for storing a state corresponding to each term in the set of terms, and a state corresponding to a term is used for charactering whether the term has been added to any extended sentence;
in a process of the traversing, in response to a term being added to an extended sentence, updating a state corresponding to the term in the array; and
wherein traversing the terms in the set of terms not added to any extended sentence in turn comprises:
traversing the terms in the set of terms not added to any extended sentence in turn according to the array.

5. The method according to claim 3, wherein judging whether the piece of position information of the traversed current term and the piece of position information of the term previously added to the current extended sentence are connected comprises:
judging whether a position and/or offset of the traversed current term and a position and/or offset of the term previously added to the current extended sentence are connected.

6. The method according to claim 5, wherein judging whether the position and/or offset of the traversed current term and the position and/or offset of the term previously added to the current extended sentence are connected comprises:
judging whether a startoffset of the current term and an endoffset of the term previously added to the current extended sentence are connected, and/or judging whether the startoffset of the current term and that of the term previously added to the current extended sentence are the same, and a position of the term previously added to the current extended sentence is in an increasing relationship with that of the current term; and
in response to the startoffset of the current term and the endoffset previously added to the current extended sentence are connected, or the startoffset of the current term and that of the term previously added to the current extended sentence being the same, and the position of the term previously added to the current extended sentence being in the increasing relationship with that of the current term, determining that the piece of position information of the current term and the piece of position information of the term previously added to the current extended sentence are connected.

7. The method according to claim 1, wherein obtaining the processing result based on the extended sentence and the NLP model comprises:
inputting the extended sentence into the NLP model, rewriting the extended sentence through the NLP model to obtain a rewritten extended sentence, and performing natural language processing according to the rewritten extended sentence to obtain the processing result.

8. The method according to claim 1, wherein obtaining the processing result based on the extended sentence and the NLP model comprises:
inputting the extended sentence into the NLP model, obtaining a sentence vector corresponding to the extended sentence through the NLP model, and performing vector processing according to the sentence vector to obtain the processing result.

9. The method according to claim 1, wherein obtaining the processing result based on the extended sentence and the NLP model comprises:
querying the extended sentence through the natural language model to obtain a query result and a matching score between the query result and the extended sentence.

10. The method according to claim 1, wherein the extended terms of the initial terms include one or more of the following:
synonyms of the initial terms, pinyin of the initial terms, and terms in standard format corresponding to the initial terms.

11. The method according to claim 1, wherein obtaining the set of terms corresponding to the initial input sentence comprises:
calling an analyzer of a search engine to obtain the set of terms corresponding to an initial input sentence, wherein the analyzer is a component of the search engine for processing text data, and the analyzer comprises one or more of the following analyzers: a tokenizer, a synonym analyzer, a pinyin analyzer, and a multilingual text analyzer.

12. An electronic device comprising: a processor and a memory, wherein
the memory stores computer-executed instructions; and
the processor executes the computer-executed instructions stored in the memory such that the processor performs a method for processing natural language comprising:
obtaining a set of terms corresponding to an initial input sentence, wherein the set of terms comprises initial terms included in the initial input sentence and extended terms of the initial terms;
performing word order restoring on terms in the set of terms to obtain an extended sentence of the initial input sentence; and
obtaining a processing result based on the extended sentence and a Natural Language Process (NLP) model.

13. The electronic device according to claim 12, wherein performing word order restoring on the terms in the set of terms to obtain the extended sentence of the initial input sentence comprises:
traversing terms in the set of terms, and obtaining terms with pieces of position information connected from the set of terms to construct an extended sentence, wherein the pieces of position information are corresponding positions and/or offsets of terms in the initial input sentence.

14. The electronic device according to claim 13, where traversing the terms in the set of terms, and obtaining the terms with the pieces of position information connected from the set of terms to construct the extended sentence comprises:
traversing terms in the set of terms not added to any extended sentence in turn, and judging whether a piece of position information of a traversed current term and a piece of position information of a term previously added to a current extended sentence are connected;
in response to the two pieces of position information being connected, adding the current term to the current extended sentence to be located after the term previously added to the current extended sentence; or
in response to the two pieces of position information not being connected, skipping the current term; and
at the end of the traversing, completing construction of the current extended sentence, and traversing again terms in the set of terms not added to any extended sentence in turn to construct a new extended sentence.

15. The electronic device according to claim 14, wherein the method further comprises:
creating an array according to the set of terms, wherein each bit of the array is used for storing a state corresponding to each term in the set of terms, and a state corresponding to a term is used for charactering whether the term has been added to any extended sentence;
in a process of the traversing, in response to a term being added to an extended sentence, updating a state corresponding to the term in the array; and
wherein traversing the terms in the set of terms not added to any extended sentence in turn comprises:
traversing the terms in the set of terms not added to any extended sentence in turn according to the array.

16. The electronic device according to claim 14, wherein judging whether the piece of position information of the traversed current term and the piece of position information of the term previously added to the current extended sentence are connected comprises:
judging whether a position and/or offset of the traversed current term and a position and/or offset of the term previously added to the current extended sentence are connected.

17. The electronic device according to claim 16, wherein judging whether the position and/or offset of the traversed current term and the position and/or offset of the term previously added to the current extended sentence are connected comprises:
judging whether a startoffset of the current term and an endoffset of the term previously added to the current extended sentence are connected, and/or judging whether the startoffset of the current term and that of the term previously added to the current extended sentence are the same, and a position of the term previously added to the current extended sentence is in an increasing relationship with that of the current term; and
in response to the startoffset of the current term and the endoffset previously added to the current extended sentence are connected, or the startoffset of the current term and that of the term previously added to the current extended sentence being the same, and the position of the term previously added to the current extended sentence being in the increasing relationship with that of the current term, determining that the piece of position information of the current term and the piece of position information of the term previously added to the current extended sentence are connected.

18. The electronic device according to claim 12, wherein obtaining the processing result based on the extended sentence and the NLP model comprises:
inputting the extended sentence into the NLP model, rewriting the extended sentence through the NLP model to obtain a rewritten extended sentence, and performing natural language processing according to the rewritten extended sentence to obtain the processing result.

19. The electronic device according to claim 12, wherein obtaining the processing result based on the extended sentence and the NLP model comprises:
inputting the extended sentence into the NLP model, obtaining a sentence vector corresponding to the extended sentence through the NLP model, and performing vector processing according to the sentence vector to obtain the processing result.

20. A non-transitory computer-readable storage medium, wherein the computer-readable storage medium has computer-executable instructions stored therein which, when executed by a processor, cause the processor to implement a method for processing natural language comprising:
obtaining a set of terms corresponding to an initial input sentence, wherein the set of terms comprises initial terms included in the initial input sentence and extended terms of the initial terms;
performing word order restoring on terms in the set of terms to obtain an extended sentence of the initial input sentence; and
obtaining a processing result based on the extended sentence and a Natural Language Process (NLP) model.
